(19) United States
(12) Patent Application Publication
(10) Pub. No.: US 2016/0328671 A1
(43) Pub. Date: Nov. 10, 2016

(54) Skill Performance Evaluation System

(71) Applicant: PCTEST Engineering Laboratory, Inc., Columbia, MD (US)

(72) Inventors: Steve Liu, Columbia, MD (US); Justin Chao, Columbia, MD (US); Bo Qin, Columbia, MD (US); Randy Ortanez, Columbia, MD (US)

(21) Appl. No.: 14/708,287

(22) Filed: May 10, 2015

(51) Int. Cl. G06Q 10/06; G06F 17/30

(52) U.S. Cl. CPC G06Q 10/063112; G06F 17/30312

(57) ABSTRACT

A skill performance evaluation system for determining skill performance metrics for a user. The skill performance evaluation system generates a user profile for a user having a particular craft, provides a set of evaluation rules for the craft and determines one or more skill performance metrics based on the set of evaluation rules. In addition, the skill performance evaluation system provides a set of depreciation rules for the craft and determines one or more skill performance metrics for the user. The system may modify the one or more skill performance metrics upon receiving a skill retire indicator or a feedback acknowledgement indicator and a revised dynamic depreciation rate.

### FIELD OF THE INVENTION

Embodiments described herein generally relate to skill performance assessments, and more particularly to systems and methods for evaluating a user's skill performance.

### BACKGROUND OF THE INVENTION

Today, many individuals seek to assess their skill performance on an ongoing basis and in real-time. Providing computerized real-time skill performance evaluations is a great improvement over traditional manual skill performance assessments. Thus, there is a need in the art for an improved skill performance assessment system.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows a high-level block diagram of a computer system configured to operate according to an embodiment of the present disclosure;

FIG. 2 is an example of a user profile according to an embodiment of the present disclosure;

FIG. 3 is an example of a craft profile according to an embodiment of the present disclosure;

FIG. 4 is an example of a skill profile for a user according to an embodiment of the present disclosure;

FIG. 5 is an example of a training profile according to an embodiment of the present disclosure;

FIG. 6 is an example of a default depreciation table according to an embodiment of the present disclosure;

FIG. 7 is an example of a skill depreciation profile for a user according to an embodiment of the present disclosure;

FIG. 8 is an example of a report profile for a user according to an embodiment of the present disclosure;

FIG. 9 is an example of a skill status chart for a user according to an embodiment of the present disclosure;

FIG. 10 is an example of a skill decay curve for a user according to an embodiment of the present disclosure;

FIGS. 11A-C are flow diagrams illustrating by way of example the steps that may be performed by a computer system to evaluate a user's skill performance according to an embodiment of the present disclosure.

### SUMMARY OF THE INVENTION

Exemplary embodiments disclosed herein describe a computer system and method for evaluating a user's skill performance. The method includes generating on the skill performance evaluation system a profile for a user; receiving on the skill performance evaluation system data associated with the user, the received data including a craft; storing the received data in the user's profile in one or more storage devices in the skill performance evaluation system; identifying on the skill performance evaluation system a set of evaluation rules for the craft; determining one or more skill performance metrics for the user on the skill performance evaluation system based on the set of evaluation rules; establishing on the skill performance evaluation system an electronic communications channel with a user interface device, the user interface device being configured to display content received from the skill performance evaluation system; and transmitting over the electronic communications channel data corresponding to the one or more skill performance metrics for display on the user interface device. In some embodiments, the one or more skill performance metrics include skill status and skill decay.

In some exemplary embodiments, each evaluation rule is assigned a number of points or range of points, and the method includes accruing points on the skill performance evaluation system for the user.

In some embodiments, the method may include generating on the skill performance evaluation system a skill profile for the user. The skill profile may include a list of skills for the user and a corresponding total number of points for each skill.

In some exemplary embodiments of the present disclosure, the method includes identifying on the skill performance evaluation system a set of depreciation rules and a default depreciation table for the craft; determining on the skill performance evaluation system a static depreciation rate for one or more of the user's skills based on the set of depreciation rules and the default depreciation table; and determining the one or more skill performance metrics for the user on the skill performance evaluation system based on the static depreciation rate for one or more of the user's skills.

In another exemplary embodiment of the present disclosure, the method includes receiving on the skill performance evaluation system a dynamic depreciation rate for one or more of the user's skills; and determining the one or more skill performance metrics for the user on the skill performance evaluation system based on the dynamic depreciation rate for one or more of the user's skills.

In some embodiments of the present disclosure, the system receives a skill retire indicator and modifies the one or more skill performance metrics in response to receiving the skill expiration indicator. Also, in some embodiments of the present disclosure, the system receives a revised depreciation rate indicator and modifies the one or more skill performance metrics in response to receiving the revised depreciation rate indicator.

According to another aspect of the present disclosure, there is provided an apparatus for evaluating a user's skill, a skill performance evaluation system, including a user interface device for transmitting data associated with the user over a first electronic communications channel, the user interface including a display; a performance assessment computing system (“PACS”); and a second electronic communications channel for transmitting data corresponding to the one or more skill performance metrics for display on the user interface device.

The PACS includes a microprocessor; a memory storage area; a first database stored in the memory area for storing a profile for a user, the user profile including a craft; a second database stored in the memory area for storing evaluation rules for the craft; a performance metrics module, in the memory storage area, having program instructions that, when executed by the microprocessor, cause the microprocessor to determine one or more skill performance metrics for the user based on the evaluation rules. In some embodiments, the one or more skill performance metrics include skill status and skill decay.

In some embodiments, each evaluation rule is assigned a number of points or a range of points; and the performance metrics module includes program instructions that when executed by the microprocessor, cause the microprocessor to accrue points for the user.

The PACS may include a skill profile generator module, in the memory storage area, having program instructions that, when executed by the microprocessor, cause the microprocessor to generate a skill profile for the user, the skill profile may include a list of skills for the user and a corresponding total number of points for each skill.

In some embodiments, the PACS may include a third database stored in the memory area for storing sets of depreciation rules and corresponding default depreciation tables; and a depreciation module, in the memory storage area, having program instructions that, when executed by the microprocessor, cause the microprocessor to determine a static depreciation rate for one or more of the user's skills based on a set of depreciation rules and corresponding default depreciation table and to determine one or more skill performance metrics for the user based on the static depreciation rate for one or more of the user's skills. Also, the depreciation module, in the memory storage area, may have program instructions that, when executed by the microprocessor, cause the microprocessor to determine one or more skill performance metrics for the user based on a dynamic depreciation rate for one or more of the user's skills.

According to some embodiments, the PACS includes a modification module, module, in the memory storage area, having program instructions that, when executed by the microprocessor, cause the microprocessor to modify the one or more skill performance metrics for the user in response to receiving a skill retire indicator or a revised dynamic depreciation rate indicator.

### DETAILED DESCRIPTION

The Exemplary Computer System

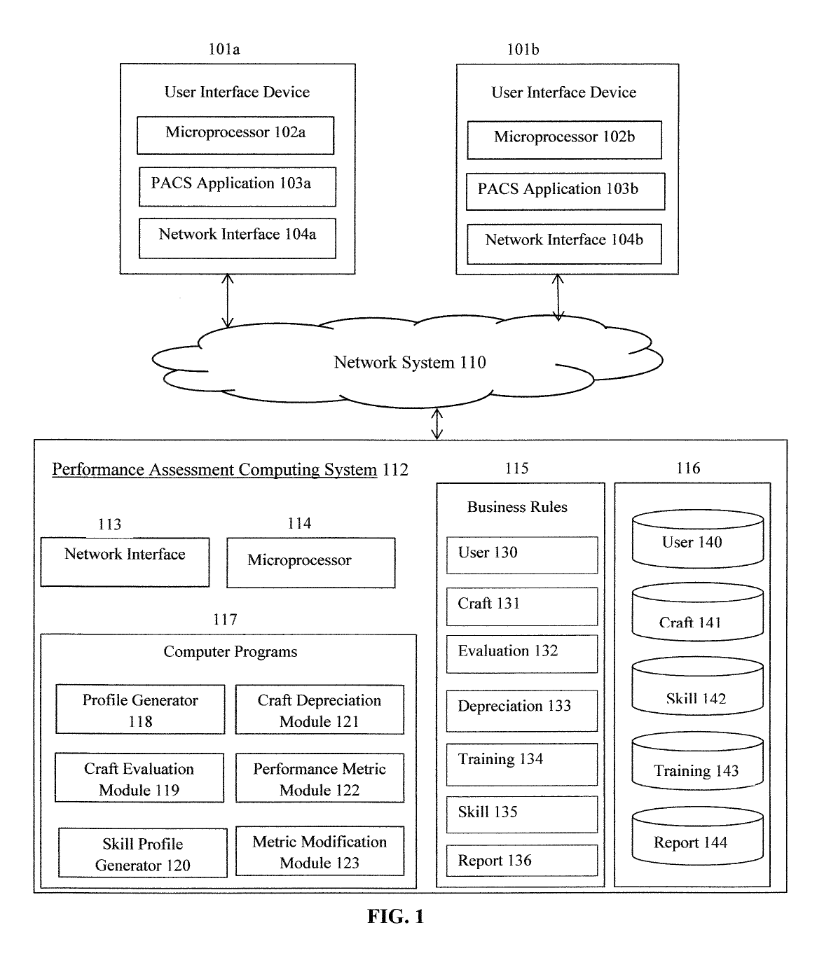

FIG. 1 shows an example of an overall computer system for evaluating a user's skill performance. The computer system includes a performance assessment computing system (“PACS”) 112, user interface devices 101a-b, and network system 110. Although not shown, the computer system includes one or more electronic communications channels for transmitting data between user interface devices 101a-b, network system 110, and PACS 112. While a limited number of user interface devices, network system and performance assessment computing system have been shown, any number of these elements may be used.

Performance Assessment Computing System

As illustrated in FIG. 1, the computer system includes an exemplary performance assessment computing system (“PACS”) 112 according to one embodiment of the present disclosure. As shown in FIG. 1, the PACS 112 includes a network interface 113, a microprocessor 114, computer programs 117 comprising a collection of software modules 118, 119, 120, 121, 122 and 123, a set of business rules 115 comprising 130, 131, 132, 133, 134, 135 and 136, and a data storage device 116, which comprises a plurality of files and/or databases 140, 141, 142, 143 and 144. As processing is performed in the PACS, outputs, such as, for example, report data and feedback information may be provided to user interface devices 101a-b. A network interface 113 is provided to establish a connection to user interface devices 101a-b. The network interface 113 may also provide connectivity to remote terminals and remote computer systems (not shown) operated by other human users who wish to access and use the PACS 112.

The PACS 112 can be any general purpose, programmable digital computing device including, for example, a personal computer, a programmable logic controller, a distributed control system, or other computing device. The PACS can include a central processing unit (CPU) or microprocessor, random access memory (RAM), non-volatile secondary storage (e.g., a hard drive, a floppy drive, and a CD-ROM drive), and network interfaces (e.g., a wired or wireless Ethernet card and a digital and/or analog input/output card). Program code, such as the code comprised in computer programs 117, and program data, such as business rules 115, can be loaded into the RAM from the non-volatile secondary storage and provided to the microprocessor 114 for execution. The microprocessor 114 can generate and store results on the data storage device for subsequent access, display, output and/or transmission to other computer systems and computer programs.

The computer programs 117, which may comprise multiple hardware or software modules, discussed hereinafter, contain program instructions that cause the microprocessor 114 to perform a variety of specific tasks required to parse, extract, index and tag data contained in the databases stored in data storage 116. Additionally, the program instructions cause the microprocessor to store data in data storage 116. These software modules are flexible, and may be configured to use a large variety of different business rules, including without limitation, user 130, craft 131, evaluation 132, depreciation 133, training 134, skill 135, and report 136. The purpose and function of each one of the computer software modules in the computer programs 117 will now be described in more detail below.

Profile Generator

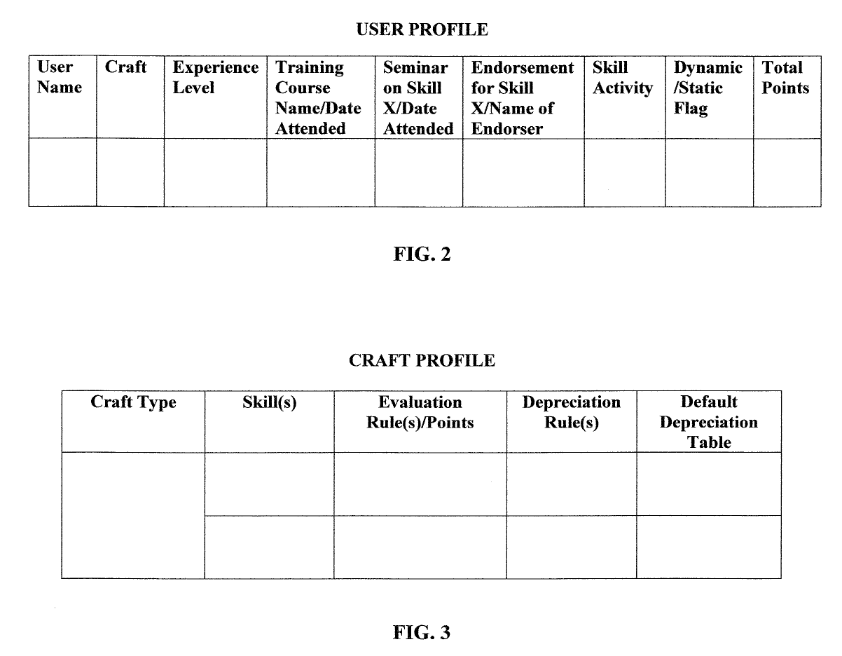

The profile generator module 118 in the computer programs 117 contains instructions that when executed by the microprocessor 114, cause the microprocessor to generate a profile for the user and store received data associated with the user in the user's profile in user database 140. The profile generator module 118 receives a new user registration request from at least one of user interface devices 101a-b. The profile generator module generates a profile for the user and stores the profile in the user database. After the profile is generated for the user, the profile generator module continues to receive data associated with the user from at least one of user interface devices 101a-b. The profile generator reads the received data and stores the contents in the appropriate field of the user's profile. The user 130 business rules are used to process and store the received data. An example of a user's profile is illustrated in FIG. 2. The profile may include information, such as, for example, “User Name”, “Craft”, “Experience Level”, “Training Course Name/Date Attended”, “Seminar on X/Date Attended”, “Endorsement for Skill X/Name of Endorser”, “Skill Activity”, “Dynamic/Static Flag”, and “Total Points”.

Craft Evaluation

The craft evaluation module 119 in the computer programs 117 contains instructions that when executed by the microprocessor 114, cause the microprocessor to identify a set of evaluation rules for the user's craft. The craft evaluation module extracts the user's craft from the user's profile and searches the craft database 141 for the craft. The craft database includes a profile for each craft stored therein. The craft evaluation module reads and extracts the contents of the craft's profile, if the craft is found in the database, to identify certain data of the craft, such as, for example, skills and evaluation rules/points. The craft evaluation module may be configured to utilize a document schema to parse and extract the content. The user 130, craft 131 and evaluation 132 business rules are used to process the extracted content. An example of a craft profile is illustrated in FIG. 3. The craft profile may include “Craft Type”, “Skills”, “Evaluation Rule(s)/Point(s)”, “Depreciation Rule(s)”, Default Depreciation Table”.

Skill Profile Generator

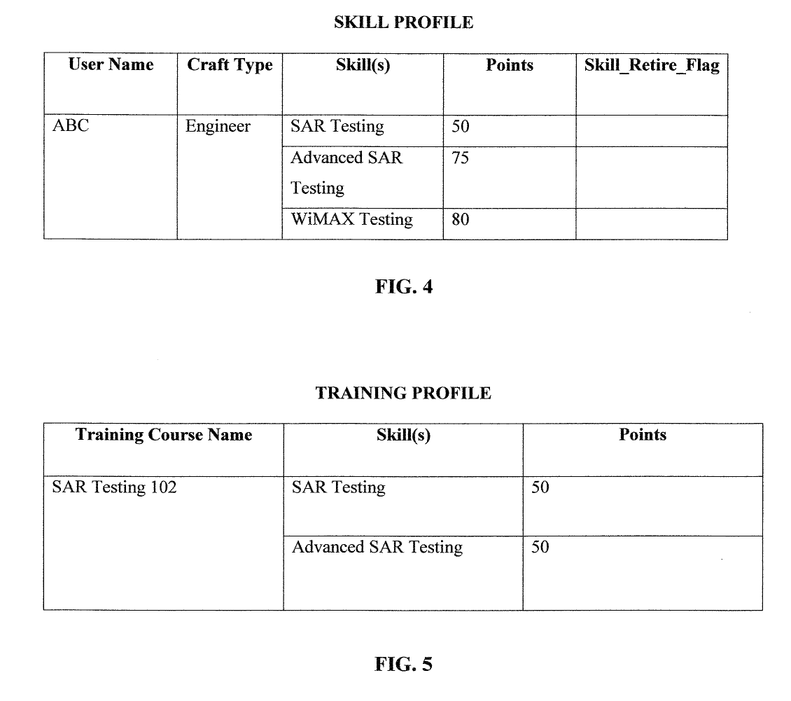

The skill profile generator module 120 in the computer programs 117 contains instructions that when executed by the microprocessor 114, cause the microprocessor to generate a skill profile for the user and store the user's skill profile in skill database 142. The skill profile generator receives the craft's evaluation rules and skills from the craft evaluation module 119, and parses and extracts the relevant content from the user's profile (i.e., evaluation parameters) and from training database 143. The skill profile generator 120 includes the set of skills received from the craft evaluation module in the skill profile for the user, and assigns points to each skill based on the evaluation rules received from the craft evaluation module and the information extracted from the user's profile and the training profile. The skill profile generator may be configured to utilize a document schema to parse and extract the content. The user 130, craft 131, training 134 and skill 135 business rules are used to process the extracted content. As illustrated in FIG. 4, the skill profile for the user may include information, such as, for example, “User Name”, “Craft Type”, “Skill(s)”, “Points”, and “Skill_Retire_Flag”.

The training database 143 contains a profile for each entry, and each profile may include information, such as, for example, “Training Course Name”, “Skills” and “Points”. Each training course is associated with one or more skills and each skill is assigned a number of points. For example, for the training course “SAR Testing 102”, the skill profile generator searches training database 143 for this course name. As illustrated in FIG. 5, the training course entry “SAR Testing 102” may be associated with one or more skills, such as, for example, “SAR Testing”, which is assigned “50” points and “Advanced SAR Testing”, which is assigned “50” points.

Craft Depreciation

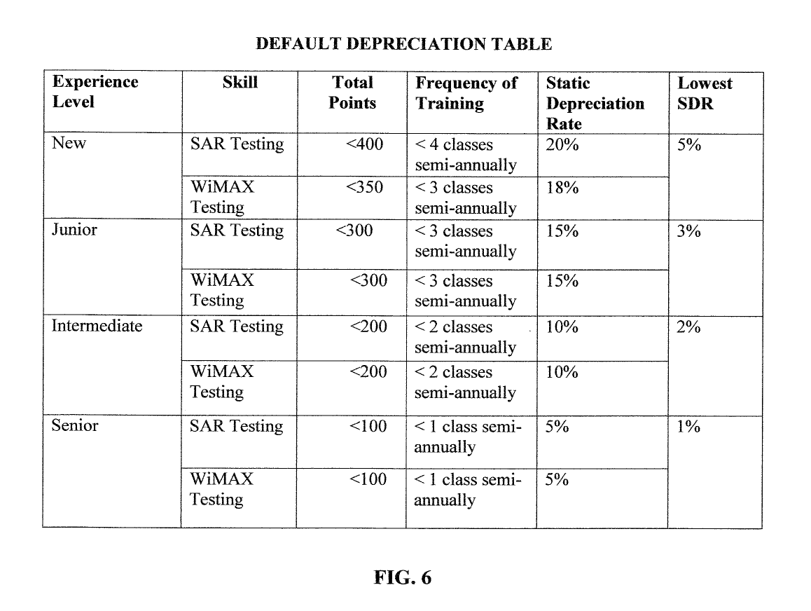

The craft depreciation module 121 in the computer programs 117 contains instructions that when executed by the microprocessor 114, cause the microprocessor to determine whether the depreciation rate for the user is static or dynamic. When the depreciation rate for the user is determined to be static, the craft depreciation module further contains instructions that when executed by the microprocessor, cause the microprocessor to identify a set of depreciation rules and a default depreciation table for the craft and determine a static depreciation rate for one or more of the user's skills based on the set of depreciation rules and the default depreciation table. The craft depreciation module may be configured to utilize a document schema to parse and extract the content. The user 130, craft 131 and depreciation 133 business rules are used to process the extracted content. An exemplary default depreciation table is illustrated in FIG. 6. The default depreciation table may include information, such as, for example, “Experience Level”, “Skill”, “Total Points”, “Frequency of Training”, “Static Depreciation Rate”, and “Lowest SDR”.

When the depreciation rate for the user is determined to be dynamic, the craft depreciation module further contains instructions that when executed by the microprocessor, cause the microprocessor to receive a dynamic depreciation rate for one or more of the user's skills from an electronic communications channel.

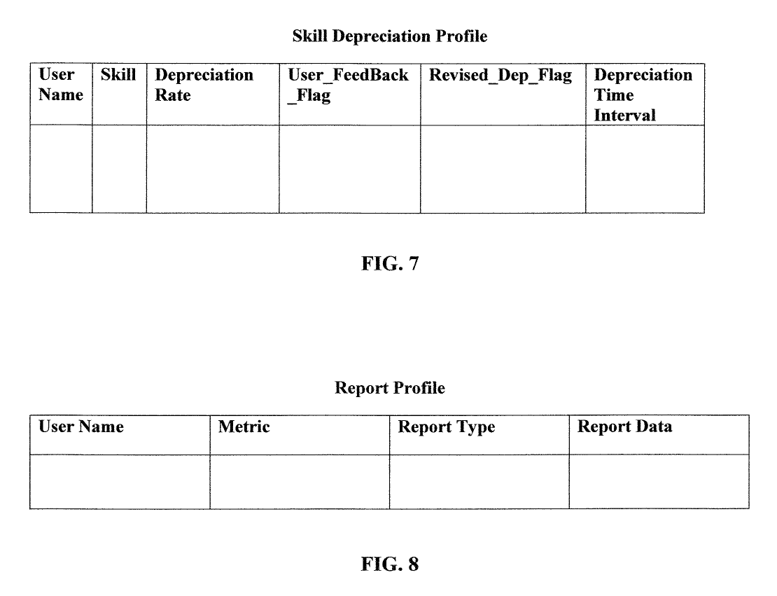

The craft depreciation module generates a skill depreciation profile for the user and stores the profile in skill database 142. The skill depreciation profile includes a depreciation rate (static or dynamic) for each of the user's skills. An example of a skill depreciation profile is illustrated in FIG. 7. The skill depreciation profile may include information, such as, for example, “User Name”, “Skill”, “Depreciation Rate”, “User_Feedback_Flag”, “Revised_Dep_Flag”, and “Depreciation Time Interval”.

Performance Metric

The performance metric module 122 in the computer programs 117 contains instructions that when executed by the microprocessor 114, cause the microprocessor to determine one or more skill performance metrics for the user based on the set of evaluation rules. In some exemplary embodiments, the performance metric module contains instructions that when executed by the microprocessor 114, cause the microprocessor to determine one or more skill performance metrics for the user based on the static depreciation rate for one or more of the user's skills or based on the dynamic depreciation rate for one or more of the user's skills. The performance metric module extracts content from craft database 141 and skill database 142 for processing. The performance metric module generates and stores a report profile for the user in report database 144. The performance metric module may be configured to utilize a document schema to parse and extract the content. The craft 131, depreciation 133 and skill 135 business rules are used to process the extracted content. An example of a user's report profile is illustrated in FIG. 8. The report profile may information, such as, for example, “User Name”, “Metric”, Report Type”, and “Report Data”.

Metric Modification

The metric modification module 123 in the computer programs 117 contains instructions that when executed by the microprocessor 114, cause the microprocessor to modify one or more skill performance metrics for the user in response to receiving a skill retire indicator or a revised depreciation rate indicator. The metric modification module extracts content from skill database 142, and report database 144 for processing. The metric modification module may be configured to utilize a document schema to parse and extract the content. The skill 135 and report 136 business rules are used to process the extracted content.

Data Storage (Database)

The data storage component 116 may comprise one or more separate data storage devices, as shown. Alternatively, data storage 116 may be implemented in a single storage device having a plurality of files or a plurality of segmented memory tables operating under the control of a database management system (not shown), but which may be incorporated into the data storage component 116 or which may be a separate processor. The data storage device 116 may house a user database 140 for storing user profiles, a craft database 141 for storing craft profiles, a skill database 142 for storing skill profiles and skill depreciation profiles, a training database 143 for storing training profiles for training courses, and a report database 144 for storing reports pertaining to the user's skill performance metrics.

User Interface Device

As illustrated in FIG. 1, user interface devices 101a-b include microprocessors 102a-b, PACS platform applications 103a-b, and a network interfaces 104a-b. User interface devices 101a-b, can be any computer processing device, such as, for example, a mobile phone, laptop, desktop, any kind of handheld computer processing system, a personal computer, minicomputer, microprocessor, workstation, mainframe, or similar computing platform. Each user interface device includes memory, communication modules, display, user interface and applications (all not shown). The communication modules include a network module, such as, for example, a wireless network card, for communication with network system 110 and performance assessment computing system 112. The communication modules can be processors embedded with computer readable instructions that when executed perform various communication functions.

User interface devices 101a-b include a controller and data storage device (not shown). The controller can include one or more microprocessors, computer readable memory (e.g., read-only memory (ROM), random access memory (RAM), mechanisms and structures for performing I/O operations. The controller can execute an operating system for execution on the central processing unit and one or more application programs to control the operation of the user interface devices. The data storage device stores one or more databases, the operating system and one or more application programs.

The PACS platform applications 103a-b, which may comprise multiple hardware or software modules, contain program instructions that cause the microprocessors 102a-b to perform a variety of specific tasks required to receive/send data from/to PACS 112. Outputs, such as, for example, user data, dynamic depreciation rate, revised depreciation rate, skill retire indicator may be provided to PACS 112. The network interfaces 104a-b are provided to establish a connection to PACS 112. The network interfaces 104a-b may also provide connectivity to remote terminals and remote computer systems (not shown).

Network System

Network system 110 may include a plurality of computers or servers (not shown) located in many different geographic locations. The network system may comprise, for example, a wide area network (WAN), a local area network (LAN) or the Internet. The network system provides communication among the devices in the computer system using one or more communications protocols.

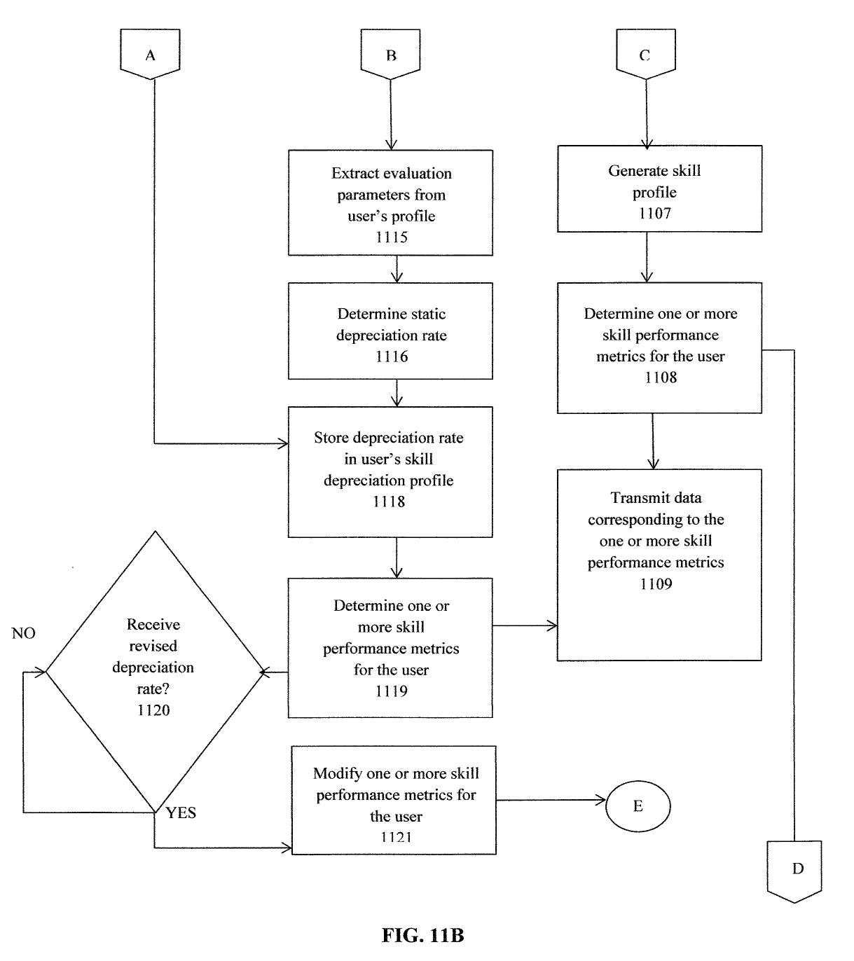

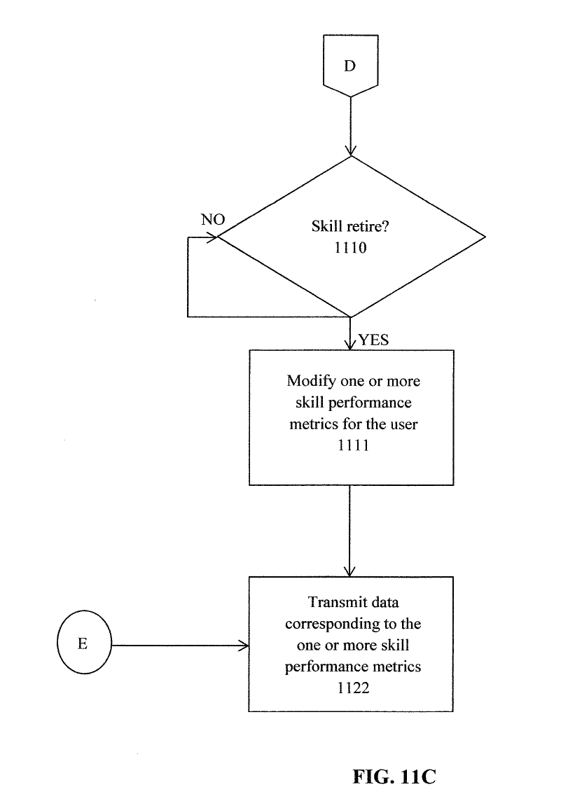

FIGS. 11A-C show a flow diagram illustrating, by way of example, the steps performed in computer programs 117 that may be implemented in accordance with certain embodiments of the present disclosure, such as, the performance assessment computing system (“PACS”), to evaluate a user's skill performance. The steps may be implemented via a conventional computer software program comprising a plurality of related functional modules each having program instructions for execution by the microprocessor 114 of FIG. 1, or it may be implemented by any other suitable machine or device without departing from the scope of the present disclosure.

As illustrated in step 1101, the first step includes generating a profile (e.g., see FIG. 2) for a user. When a new user registers to use the PACS application 102, the PACS 112 generates a profile for the user. Next, at steps 1102 and 1103, the PACS receives data associated with the user from at least one of user interface devices 101a-b, and stores the data in the appropriate field of the user's profile.

At steps 1104 and 1105, the PACS 112 looks-up the user's craft in craft database 141 and identifies the evaluation rules associated with the craft. The PACS extracts the craft's set of skills and evaluation rules/points from the craft profile. Each craft entry in craft database is associated with a set of skills, a set of evaluation rules, a set of depreciation rules, and a default depreciation table (e.g., see FIG. 3). Each evaluation rule is assigned a number of points or a range of points. For example, a user may have a craft of “Engineer”, which may be associated with a set of skills, such as, for example, “SAR testing”, “Advanced SAR Testing” and “WiMAX Testing”, and which may be associated with a set of evaluation rules/points, such as for example, “training/50-150 points”, “seminar on skill X, 75 points”, “self-endorsement for skill Y, 5 points”, “peer endorsement for skill X, 25 points”, and “skill activity, 50 points”.

At steps 1106 and 1107, the PACS 112 extracts content (i.e., the evaluation parameters) from the user's profile in user database 140 and training database 143, and generates a skill profile for the user. The evaluation parameters extracted from the user's profile may include information, such as, for example, “Training Course Name/Date Attended”, “Seminar on Skill X/Date Attended”, “Endorsement for Skill X/Name of Endorser”, and “Skill Activity”. The content extracted from the training database 143 may include, for example, a training profile for each training class attended by the user. The training classes attended by the user are identified in the “Training Course Name/Date Attended” field of the user's profile.

The PACS 112 includes the set of skills associated with the user's craft in the skill profile (e.g., see FIG. 4) generated for the user, and assigns points to each skill based on the craft's evaluation rules and the information extracted from the user's profile and the training profile. For example, user “ABC” may have a craft of “Engineer”; the craft may be associated with skills, “SAR Testing”, “Advanced SAR Testing”, and “WiMAX Testing”; the craft may be associated with evaluation rules/points “training, 50-150 points”, “seminar on skill X, 75 points”, “self-endorsement for skill Y, 5 points”, “peer endorsement for skill X, 25 points”, “skill activity, 50 points”; and the extracted content from the user profile may include, “SAR Testing 102/12/4/2014”, “Seminar on WiMAX Testing/11/20/2014”, “Peer Endorsement for Advanced SAR Testing”, “Self-Endorsement for WiMAX testing”.

Further, the extracted content from the training database 143 may include “SAR Testing 102”, “SAR Testing, 50 points”, “Advanced SAR Testing, 50 points”. In this example, skill “SAR Testing” is assigned a total number of 50 points, consisting of training points; skill “Advanced SAR Testing” is assigned a total number of 75 points, consisting of 50 points for training and 25 points for peer endorsement, and skill “WiMAX Testing” is assigned a total number of 80 points, consisting of 75 points for seminar and 5 points for self-endorsement. The training points for the skills are obtained from the training profile (e.g., see FIG. 5) for the training course attended by the user.

At step 1108, the PACS 112 determines one or more skill performance metrics for the user. The PACS reads and extracts the contents of the user's skill profile from skill database 142, to identify certain data of the user, such as, for example, “Skills” and “Points”. The PACS uses the data from the user's skill profile to determine one or more skill performance metrics for the user, such as, for example, skill status. As noted above, each skill in the user's skill profile is assigned a corresponding point value. The point value is derived from an analysis of the user's evaluation parameters using the craft's set of evaluation rules, and corresponds to the total number of points the user accrued for a particular skill. The point value may represent information, such as, for example, the user's score for a particular skill.

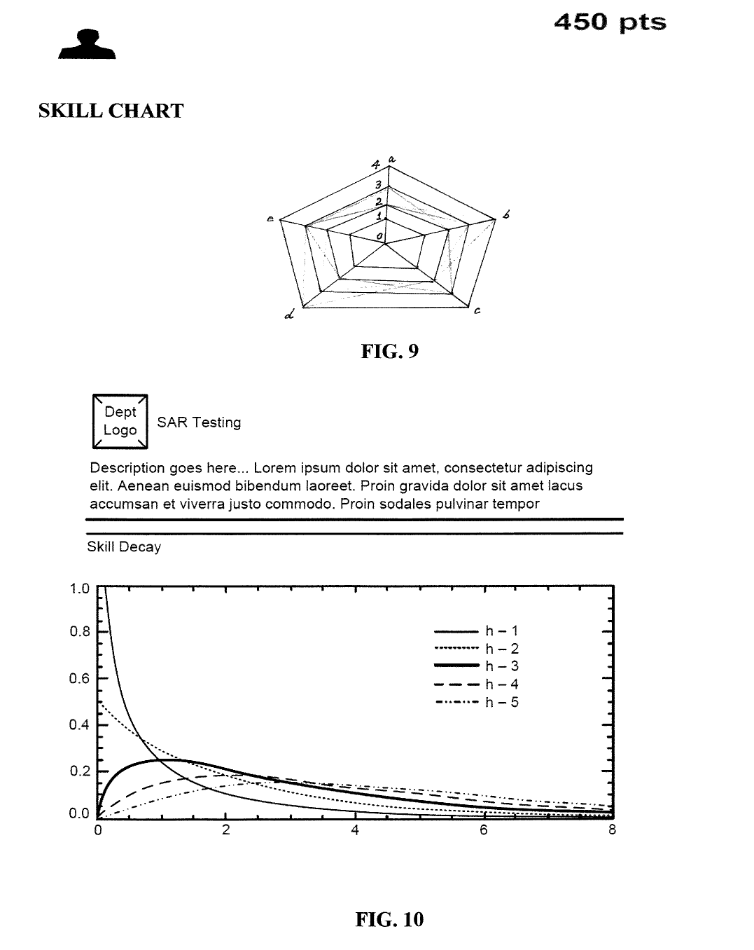

The PACS 112 may determine one or more metrics for the user, such as, for example, the user's skill status, by plotting the user's skills and corresponding scores on a chart. The PACS stores the chart in the user's report profile (e.g., see FIG. 8) in report database 144. FIG. 9 illustrates an exemplary chart of the user's skill status. Each spoke of the chart may represent, for example, a different user skill, and the data length of the spoke is proportional to the magnitude of the variable (i.e., skill) for the data point relative to the maximum magnitude of the variable across all data points. Each color plot may represent, for example, a set of scores for the skills from a different time period. Although the exemplary chart shown in FIG. 9 is a spider chart, any type of chart or graph may be used. Further, any different number of charts or graphs may be plotted.

At step 1109, the PACS 112 transmits data corresponding to the one or more skill performance metrics for the user over an electronic communications channel to user interface device 101. The user interface device may display the data on the device.

At steps 1110 and 1111, the PACS 112 determines whether a skill retire indicator has been received, and if so, the PACS modifies one or more skill performance metrics for the user. The PACS reads and extracts the contents of the user's skill profile, to identify certain data, such as, for example, “Skill_Retire_Flag”. Also, the PACS reads and extracts the contents of the user's report profile from report database 144, to identify certain data of the user, such as, for example, “Metric”, “Report Type” and “Report Data”.

When the PACS 112 determines that the “Skill_Retire_Flag” is set to “1” for one or more of the user's skills, the PACS may modify one or more skill performance metrics for the user, such as, for example, the user's skill status, by deleting the one or more retired skills from the user's skill status chart and updating the user's report profile in report database 144.

At step 1112, the PACS 112 determines whether the user is registered to receive a dynamic depreciation rate or a static depreciation rate by reading the “Dynamic/Static Flag” in the user's profile. If the flag is set to “1”, then the user is registered to receive a dynamic depreciation rate. If the flag is set to “0”, then the user is registered to receive a static depreciation rate.

When the flag is set for a static depreciation rate, the PACS 112 looks-up the user's craft in craft database 141 and identifies a set of depreciation rules and a default depreciation table associated with the craft, at steps 1113 and 1114. The PACS 112 extracts the user's craft from the user's profile, searches the craft database 141 for the craft, and reads and extracts the contents of the craft's profile, to identify certain data of the craft, such as, for example, “Depreciation Rule(s)”, and “Default Depreciation Table”.

As noted above, each craft profile includes a set of depreciation rules and a default depreciation table. The depreciation rules define the evaluation parameters used to determine a depreciation rate for one or more of the user's skills. The default depreciation table defines the parameters for assigning a static depreciation rate to one or more of the user's skills. For example, a user may have a craft of “Engineer”, which may be associated with a set of depreciation rules, such as, for example, “experience level”, “frequency of training”, and “total points”, and which may be associated with a default depreciation table, such as, for example, the table illustrated in FIG. 6.

At steps 1115 and 1116, the PACS 112 extracts the evaluation parameters, consistent with the craft's depreciation rules, from the user's profile and evaluates the evaluation parameters and the default depreciation table to determine a static depreciation rate for the user's skill(s). The evaluation parameters extracted from the user's profile may include, for example, “Experience Level”, “Training Course Name/Date Attended”, and “Total Points”.

The PACS 112 evaluates the evaluation parameters and the default depreciation table to determine a static depreciation rate for the user's skills. For example, the user's evaluation parameters may include the following data values: experience level “junior”, training data “SAR Testing 102/12/14/2014”, “WiMAX Testing 3/1/2014”, and total points “SAR Testing, 325”, “WiMAX Testing, 100”. The relevant entry in the default depreciation table may include the following information:

| | | | Frequency | Static | |
|---|---|---|---|---|---|
| Experience | | Total | of | Deprecation | Lowest |
| Level | Skill | Points | Training | Rate | SDR |
| Junior | SAR Testing | <300 | <3 classes | 15% | 3% |
| | | | semi-annually | | |
| | WiMAX | <300 | <3 classes | 15% | |
| | Testing | | semi-annually | | |

In this example, the user is assigned a static depreciation rate of 15% for skill “SAR Testing” since the user has a junior experience level and attended less than three (3) classes semi-annually. Although, the user has more than 300 points for the skill “SAR Testing”, the user is still assigned a static depreciation rate of 15% since the user has attended less than three (3) classes semi-annually. If either the designated amount of points (e.g., <300) or the designated amount of training (e.g., <3 classes semi-annually) is true, then the user is assigned the designated static depreciation rate. The user is assigned a static depreciation rate of 15% for skill “WiMAX Testing” since the user has a junior experience level, with less than 300 total points and attended less than three (3) classes semi-annually.

If both the designated amount of points and the designated amount of training are false, then the user is assigned a lowest static depreciation rate designated for the user's experience level. Each experience level is designated a lowest static depreciation rate. For example, as illustrated in FIG. 6, experience level “New” may be assigned a lowest static depreciation rate of 5%, experience level “Junior” may be assigned a lowest static depreciation rate of 3%, experience level “Intermediate” may be assigned a lowest static depreciation rate of 2% and experience level “Senior” may be assigned a lowest static depreciation rate of 1%.

When the PACS 112 determines that the “Dynamic/Static Flag” is set to receive a dynamic depreciation rate, the PACS, at step 1117, waits to receive the dynamic depreciation rate over the electronic communications channel.

At step 1118, the PACS 112 generates a skill depreciation profile (e.g., see FIG. 7) for the user in skill database 142 and stores the skill and corresponding depreciation rate (i.e. static or dynamic) in the profile.

At step 1119, the PACS 112 determines one or more skill performance metrics for the user. The PACS determines one or more skill performance metrics for the user based on the static depreciation rate for one or more of the user's skills or based on the dynamic depreciation rate for one or more of the user's skills. The PACS reads and extracts the contents of the user's skill depreciation profile from skill database 142, to identify certain data of the user, such as, for example, “Skill”, “Depreciation Rate” and “Depreciation Time Interval”.

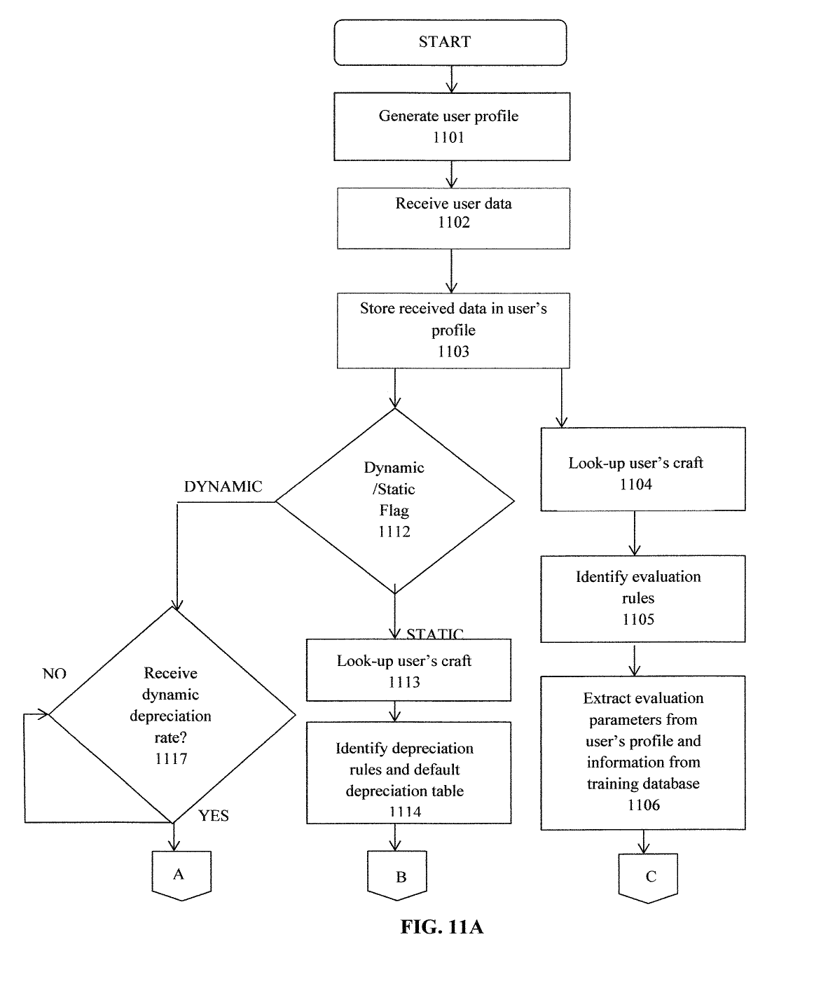

The PACS 112 uses the data from the user's skill depreciation profile to determine one or more skill performance metrics for the user, such as, for example, skill decay. The PACS may determine the user's skill decay for a particular skill by plotting a decay curve for the skill based on the skill's depreciation rate and depreciation time interval. FIG. 10 illustrates an exemplary graph of the user's skill decay. The PACS stores the graph in the user's report profile in report database 144.

At steps 1120 and 1121, the PACS 112 modifies one or more skill performance metrics for the user, such as, for example, the user's skill decay, in response to determining that a revised depreciation rate has been set for one or more of the user's skills. When a user desires to challenge the current depreciation rate assigned to one or more of the user's skills, the user provides feedback information, which causes the “User_Feedback_Flag” in the user's skill depreciation profile to be set. The user feedback may include, for example, factors and/or reasons as to why the current depreciation rate should be changed. If the challenge is successful, the “Revised_Dep_Flag” will be set.

The PACS 112 reads and extracts the contents of the user's skill depreciation profile, to identify certain data, such as, for example, “Revised_Dep_Flag”. The PACS reads and extracts the contents of the user's report profile from report database 144, to identify certain data of the user, such as, for example, “Metric”, “Report Type” and “Report Data”. When the PACS determines that the “Revised_Dep_Flag” is set for one or more of the user's skills, the PACS may modify one or more skill performance metrics for the user, such as, for example, the user's skill decay by re-plotting the skill decay curve for each skill having a revised depreciation rate using the revised depreciation rate, which is stored in the user's skill depreciation profile in the “Depreciation Rate” field, and updating the user's report profile in report database 144.

At step 1122, the PACS 112 transmits data corresponding to the one or more skill performance metrics for the user over an electronic communications channel to user interface device 101. The user interface device may display the data on the device.

Although some of the exemplary embodiments described herein are tailored to an “Engineer” craft, the present disclosed systems and methods is not limited to such craft, and can be used with any type of craft including, for example, fitness and cooking.

The disclosed embodiments are not inclusive and many other modifications and variations will be apparent to someone of ordinary skill in the art with construction skills in the related arts. Further, the steps of the disclosed methods can be modified in various manners, including by reordering steps, executing multiple steps concurrently, and/or inserting or deleting steps, without departing from the principles of the invention. Together the descriptions and accompanying illustrations seek to provide an explanation of the basic principles of the embodiment and its application. It is therefore intended that the specification and embodiments be considered as exemplary only.

Those skilled in the art will recognize and appreciate that FIGS. 2-7 are non-limiting examples of various profiles and tables that could be utilized according to some embodiments of the present disclosure, and that suitable profiles and tables may also include a greater or fewer number of fields, as well as different field values, without departing from the scope of the present invention.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software.

The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

The machine readable medium may include any mechanism for storing, transmitting, or receiving information in a tangible form readable by a machine, and the medium may include a tangible medium through which the program code may pass, such as antennas, optical fibers, communications interfaces, etc. Program code may be transmitted in the form of packets, serial data, parallel data, etc., and may be used in a compressed or encrypted format.

Program code, or instructions, may be stored in, for example, volatile and/or non-volatile memory, such as storage devices and/or an associated machine readable or machine accessible medium including, but not limited to, solid-state memory, hard-drives, floppy-disks, optical storage, tapes, flash memory, memory sticks, digital video disks, digital versatile discs (DVDs), etc., as well as more exotic mediums such as machine-accessible biological state preserving storage.

The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method of evaluating a user's skill performance using a skill performance evaluation system (“SPES”), the method comprising:
generating on the skill performance evaluation system a profile for the user;
receiving on the skill performance evaluation system data associated with the user, the received data including a craft;
storing the received data in the user's profile in one or more storage devices in the skill performance evaluation system;
identifying on the skill performance evaluation system a set of evaluation rules for the craft;
determining one or more skill performance metrics for the user on the skill performance evaluation system based on the set of evaluation rules;
establishing on the skill performance evaluation system an electronic communications channel with a user interface device, the user interface device being configured to display content received from the skill performance evaluation system; and
transmitting over the electronic communications channel data corresponding to the one or more skill performance metrics for display on the user interface device.

2. The method of claim 1, further comprising:
generating on the skill performance evaluation system a skill profile for the user, the skill profile including a list of skills and a corresponding total number of points for each skill.

3. The method of claim 1, further comprising:
identifying on the skill performance evaluation system a set of depreciation rules and a default depreciation table for the craft.

4. The method of claim 3, further comprising:
determining on the skill performance evaluation system a static depreciation rate for one or more of the user's skills based on the depreciation rules and the default depreciation table; and
determining one or more skill performance metrics for the user on the skill performance evaluation system based on the static depreciation rate for one or more of the user's skills.

5. The method of claim 1, further comprising:
receiving on the skill performance evaluation system a dynamic depreciation rate for one or more of the user's skills; and
determining one or more skill performance metrics for the user on the skill performance evaluation system based on the dynamic depreciation rate for one or more of the user's skills.

6. The method of claim 1, further comprising:
receiving on the skill performance evaluation system a skill retire indicator;
modifying on the skill performance evaluation system the one or more skill performance metrics in response to receiving a skill retire indicator.

7. The method of claim 5, further comprising:
receiving on the skill performance evaluation system a revised depreciation rate indicator; and
modifying on the skill performance evaluation system the one or more skill performance metrics in response to receiving the revised depreciation rate indicator.

8. The method of claim 1, wherein each rule within the set of evaluation rules is assigned a number of points or range of points.

9. The method of claim 1, wherein the step of determining one or more skill performance metrics for the user based on the set of evaluation rules includes accruing on the skill performance evaluation system points for the user.

10. The method of claim 1, wherein the one or more skill performance metrics determined for the user is to include one or more of skill status and skill decay.

11. A skill performance evaluation system comprising:
a user interface device for transmitting data associated with a user over a first electronic communications channel, the user interface device including a display;
a performance assessment computing system (“PACS”) comprising:
a microprocessor;
a memory storage area;
a first database stored in the memory storage area for storing a profile for the user, the profile including a craft;
a second database stored in the memory storage area for storing a set of evaluation rules for the craft;
a performance metrics module, in the memory storage area, having program instructions that, when executed by the microprocessor, causes the microprocessor to determine one or more skill performance metrics for the user based on the evaluation rules; and
a second electronic communications channel for transmitting data corresponding to the one or more skill performance metrics for display on the user interface device.

12. The skill performance evaluation system of claim 11, wherein the PACS further comprises a skill profile generator module, in the memory storage area, having program instructions that, when executed by the microprocessor, causes the microprocessor to:
generate a skill profile for the user, the skill profile including a list of skills and a corresponding total number of points for each skill.

13. The skill performance evaluation system of claim 11, wherein the PACS further comprises a third database stored in the memory area for storing sets of depreciation rules and corresponding default depreciation tables.

14. The skill performance evaluation system of claim 13, wherein the PACS further comprises a depreciation module, in the memory storage area, having program instructions that, when executed by the microprocessor, causes the microprocessor to:
determine a static depreciation rate for one or more of the user's skills based on a set of the depreciation rules and a corresponding default depreciation table; and
determine one or more skill performance metrics for the user based on the static depreciation rate for one or more of the user's skills.

15. The skill performance evaluation system of claim 11, wherein the PACS further comprises a depreciation module, in the memory storage area, having program instructions that, when executed by the microprocessor, causes the microprocessor to:
determine one or more skill performance metrics for the user based on a dynamic depreciation rate for one or more of the user's skills.

16. The skill performance evaluation system of claim 11, wherein the PACS further comprises a modification module, in the memory storage area, having program instructions that, when executed by the microprocessor, causes the microprocessor to:
modify the one or more skill performance metrics in response to receiving a skill retire indicator.

17. The skill performance evaluation system of claim 15, wherein the PACS further comprises a modification module, in the memory storage area, having program instructions that, when executed by the microprocessor, causes the microprocessor to:
modify the one or more skill performance metrics in response to receiving a revised dynamic depreciation rate indicator.

18. The skill performance evaluation system of claim 11, wherein each rule within the set of evaluation rules is assigned a number of points or range of points.

19. The skill performance evaluation system of claim 18, wherein the performance metrics module further comprises program instructions that when executed by the microprocessor, causes the microprocessor to:
accrue points for the user based on the set of evaluation rules.

20. The skill performance evaluation system of claim 11, wherein the skill performance metrics determined for the user is to include one or more of skill status and skill decay.
